(19) United States
(12) Patent Application Publication
(10) Pub. No.: US 2024/0000014 A1
(43) Pub. Date: Jan. 4, 2024

(54) SYSTEMS AND METHODS FOR AUTOMATICALLY IDENTIFYING SENSORS ASSOCIATED WITH AGRICULTURAL EQUIPMENT

(71) Applicant: CNH Industrial America LLC, New Holland, PA (US)

(72) Inventors: Cory Douglas Hunt, Millersville, PA (US); Jethro Martin, Ephrata, PA (US)

(21) Appl. No.: 17/854,850

(22) Filed: Jun. 30, 2022

(51) Int. Cl. A01D 41/14; A01D 41/127

(52) U.S. Cl. CPC A01D 41/141; A01D 41/127

(57) ABSTRACT

In one aspect, method for automatically identifying sensors provided in association with agricultural equipment includes actuating, with the computing system, agricultural equipment such that an orientation of the agricultural equipment is varied in at least one direction, and receiving, with the computing system, data from a plurality of sensors that is associated with a parameter that changes as the orientation of the agricultural equipment is varied, the plurality of sensors being installed relative to the agricultural equipment at spaced apart locations along the at least one direction. The method also includes identifying, with the computing system, respective locations of the plurality of sensors relative to the agricultural equipment based at least in part on the data.

### FIELD OF THE INVENTION

The present subject matter relates generally to sensors or sensing devices used with agricultural equipment, and, more particularly, to systems and methods for automatically identifying sensors associated with agricultural equipment, such as sensors used with a harvesting implement or header or any other suitable agricultural implement.

### BACKGROUND OF THE INVENTION

A harvester is an agricultural machine that is used to harvest and process crops. For instance, a forage harvester may be used to cut and comminute silage crops, such as grass and corn. Similarly, a combine harvester may be used to harvest grain crops, such as wheat, oats, rye, barely, corn, soybeans, and flax or linseed. In general, the objective is to complete several processes, which traditionally were distinct, in one pass of the machine over a particular part of the field. In this regard, most harvesters are equipped with a detachable harvesting implement, such as a header, which cuts and collects the crop from the field and feeds it to the base harvester for further processing.

Many combines typically utilize an automatic header height control system that attempts to maintain a constant cutting height above the ground regardless of the ground contour or ground position relative to the base combine. For instance, it is known to utilize electronically-controlled height and tilt cylinders to automatically adjust the height and lateral orientation, or tilt, of the header relative to the ground based on sensor measurements received from a plurality of sensors spaced apart across the header. However, to allow the system to accurately control the header height based on feedback from the sensors, the controller is required to know the position of each sensor relative to the header. To date, such information must be manually entered by the operator, or the sensors must be installed in a predetermined order along the header. For instance, some systems require that the sensors be installed on the header based on the serial numbers of the sensors such that the serial numbers increase across the header (e.g., from left-to-right or right-to-left). However, with such systems, when the operator needs to install a new sensor on the header (with a new serial number), it often requires that all or a portion of the sensors be relocated along the header to ensure that the proper order of the serial numbers is maintained. As a result, sensor installation and replacement can be a very time-consuming processor.

Accordingly, systems and methods for automatically identifying sensors associated with agricultural equipment, including automatic identification of the location of sensors relative to the equipment, would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for automatically identifying sensors provided in association with agricultural equipment. The method includes actuating, with the computing system, agricultural equipment such that an orientation of the agricultural equipment is varied in at least one direction, and receiving, with the computing system, data from a plurality of sensors that is associated with a parameter that changes as the orientation of the agricultural equipment is varied, the plurality of sensors being installed relative to the agricultural equipment at spaced apart locations along the at least one direction. The method also includes identifying, with the computing system, respective locations of the plurality of sensors relative to the agricultural equipment based at least in part on the data.

In another aspect, the present subject matter is directed to an automatic sensor identification system. The system includes agricultural equipment, a plurality of sensors installed relative to the agricultural equipment at a plurality of spaced apart locations along at least one direction, and a computing system communicatively coupled to the plurality of sensors. The computing system is configured to: cause the agricultural equipment to be actuated such that an orientation of the agricultural equipment is varied in the at least one direction; receive data from the plurality of sensors that is associated with a parameter that changes as the orientation of the agricultural equipment is varied; and identify respective locations of the plurality of sensors relative to the agricultural equipment based at least in part on the data.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, partial sectional side view of one embodiment of an agricultural harvester in accordance with aspects of the present subject matter;

FIG. 2 illustrates a simplified, schematic view of one embodiment of a harvesting attachment and related hydraulic system for an agricultural harvester in accordance with aspects of the present subject matter;

FIG. 3 illustrates a schematic view of one embodiment of a system for automatically identifying sensors associated with agricultural equipment in accordance with aspects of the present subject matter;

FIGS. 4A and 4B illustrate schematic views of an exemplary header during the execution of one embodiment of a sensor identification algorithm/routine in accordance with aspects of the present subject matter, particularly illustrating the header being tilted in the lateral direction to allow for the identification of sensors spaced apart laterally across the header;

FIGS. 5A and 5B illustrate schematic views of an exemplary header during the execution of another embodiment of a sensor identification algorithm/routine in accordance with aspects of the present subject matter, particularly illustrating the header being tilted in the fore-aft direction to allow for the identification of sensors spaced apart across the header in such direction; and

FIG. 6 illustrates a flow diagram of one embodiment of a method for automatically identifying sensors associated with agricultural equipment in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for automatically identifying sensors associated with agricultural equipment. In several embodiments, the sensors may be configured to generate data associated with a parameter that changes with variations in a position or orientation of the equipment relative to the ground. In such embodiments, an automated procedure can be implemented by a computing system so that the agricultural equipment is moved or actuated relative to the ground while sensor data is being received by the computing system from the various sensors. The detected changes in the monitored parameter from each sensor will generally vary depending on the sensor's position on the equipment. As such, by analyzing the detected changes in the monitored parameter (or lack thereof) across all of the various sensors, the computing system may identify the relative locations of the sensors on the equipment.

In several embodiments, the various sensors may be communicatively coupled to the computing system via a CAN bus or similar data connection. In such embodiments, each sensor may be configured to transmit data associated with the monitored parameter as well as identification data (e.g., a serial number or unique identification number) to the computing system across the CAN bus. In addition, the computing system may be configured to transmit instructions for changing the sensor parameters for one or more of the sensors via the CAN bus. For instance, the desired sensor parameters (e.g., sensitivity) may change depending on the various positions of the sensors along the equipment. Thus, once the computing system has identified the location of each sensor, the computing system may, if necessary, transmit location-specific instructions for changing the sensor parameters of one or more of the sensors.

It should be appreciated that, for purposes of discussion, the present subject matter will generally be described herein with reference to height sensors used in association with harvesting implements or headers. However, in other embodiments, the present subject matter be advantageously utilized to automatically identify the locations of any suitable types of sensors provided in association with any suitable agricultural equipment, including other types of agricultural implements and/or other equipment. For instance, the disclosed systems and methods may be also be advantageously utilized with sensors provided on agricultural equipment typically utilized with sprayers, such as the height sensors typically provided on the sprayer booms.

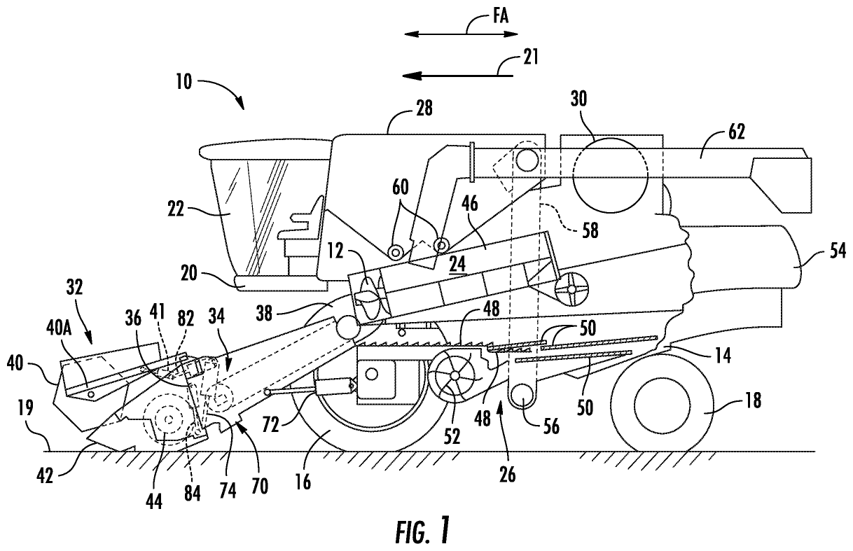

Referring now to the drawings, FIG. 1 illustrates a simplified, partial sectional side view of one embodiment of a work vehicle, such as an agricultural harvester 10. The harvester 10 may be configured as an axial-flow type combine, wherein crop material is threshed and separated while it is advanced by and along a longitudinally arranged rotor 12. The harvester 10 may include a chassis or main frame 14 extending in a fore-aft direction (indicated by arrow FA in FIG. 1) of the harvester 10, with the frame 14 including a pair of driven, ground-engaging front wheels 16 and a pair of steerable rear wheels 18 spaced apart from each other in the fore-aft direction FA. The wheels 16, 18 may be configured to support the harvester 10 relative to a ground surface 19 and move the harvester 10 in a forward direction of movement (indicated by arrow 21 in FIG. 1) relative to the ground surface 19. Additionally, an operator's platform 20 with an operator's cab 22, a threshing and separating assembly 24, a grain cleaning assembly 26 and a holding tank 28 may be supported by the frame 14. Additionally, as is generally understood, the harvester 10 may include an engine and a transmission mounted on the frame 14. The transmission may be operably coupled to the engine and may provide variably adjusted gear ratios for transferring engine power to the wheels 16, 18 via a drive axle assembly (or via axles if multiple drive axles are employed).

Moreover, as shown in FIG. 1, a harvesting implement (e.g., a header 32) and an associated feeder 34 may extend forward of the main frame 14 and may be pivotably secured thereto for generally vertical movement. In general, the feeder 34 may be configured to serve as support structure for the header 32. As shown in FIG. 1, the feeder 34 may extend between a front end 36 rotationally coupled to the header 32 and a rear end 38 positioned adjacent to the threshing and separating assembly 24. As is generally understood, the rear end 38 of the feeder 34 may be pivotably coupled to a portion of the harvester 10 to allow the front end 36 of the feeder 34 and, thus, the header 32 to be moved upwardly and downwardly relative to the ground surface 19 to set the desired harvesting or cutting height for the header 32.

In some embodiments, the header 32 includes a reel 40 rotatably coupled to a reel frame 40A which is, in turn, rotatably coupled to a frame of the header 32. The reel 40 is generally configured to contact crop material before a sickle bar 42 of the header 32. For instance, the reel 40 may include tines and/or the like such that, when crop materials contact the reel 40, the crop materials may be oriented into a substantially uniform direction and guided toward the sickle bar 42. The vertical positioning of the reel 40 (e.g., relative to the ground and/or chassis 22) may be adjusted by a reel actuator 41 coupled between the reel frame 40A and the feeder 34. For instance, the reel actuator 41 may be a cylinder which is extendable and retractable to adjust a vertical position of the reel 40.

As the harvester 10 is propelled forwardly over a field with standing crop, the crop material is directed towards the sickle bar 42 by the reel 40. The crop material is then severed from the stubble by a sickle bar 42 at the front of the header 32 and delivered by a header auger 44 to the front end 36 of the feeder 34, which supplies the cut crop to the threshing and separating assembly 24. As is generally understood, the threshing and separating assembly 24 may include a cylindrical chamber 46 in which the rotor 12 is rotated to thresh and separate the crop received therein. That is, the crop is rubbed and beaten between the rotor 12 and the inner surfaces of the chamber 46, whereby the grain, seed, or the like, is loosened and separated from the straw.

Crop material which has been separated by the threshing and separating assembly 24 falls onto a series of pans 48 and associated sieves 50, with the separated crop material being spread out via oscillation of the pans 48 and/or sieves 50 and eventually falling through apertures defined in the sieves 50. Additionally, a cleaning fan 52 may be positioned adjacent to one or more of the sieves 50 to provide an air flow through the sieves 50 that removes chaff and other impurities from the crop material. For instance, the fan 52 may blow the impurities off of the crop material for discharge from the harvester 10 through the outlet of a straw hood 54 positioned at the back end of the harvester 10.

The cleaned crop material passing through the sieves 50 may then fall into a trough of an auger 56, which may be configured to transfer the crop material to an elevator 58 for delivery to the associated holding tank 28. Additionally, a pair of tank augers 60 at the bottom of the holding tank 28 may be used to urge the cleaned crop material sideways to an unloading tube 62 for discharge from the harvester 10.

Moreover, in several embodiments, the harvester 10 may also include a header adjusting system 70 (e.g., a hydraulic system) which is configured to adjust a height of the header 32 relative to the ground surface 19 so as to maintain the desired cutting height between the header 32 and the ground surface 19. The header adjusting system 70 may include a height actuator 72 configured to adjust the height or vertical positioning of the header 32 relative to the ground. For example, in some embodiments, the height actuator 72 may be coupled between the feeder 34 and the frame 14 such that the height actuator 72 may pivot the feeder 34 to raise and lower the header 32 relative to the ground surface 19. Further, the header adjusting system 70 may include a lateral tilt actuator(s) 74 coupled between the header 32 and the feeder 34 to allow the header 32 to be tilted relative to the ground surface 19 or pivoted laterally or side-to-side relative to the feeder 34. Moreover, the header adjusting system 70 may include a fore-aft actuator(s) 82 coupled between the header 32 and the feeder 34 to allow the header 32 to be tilted in the fore-to-aft direction FA relative to the ground surface 19 or forward and backward relative to the feeder 34. Additionally, the header adjusting system 70 may include a stabilization actuator(s) 84 between the header 32 and the feeder 34 to reduce rotation of the header 32 in an opposite direction from the desired actuation direction of the fore-to-aft actuator(s) 82.

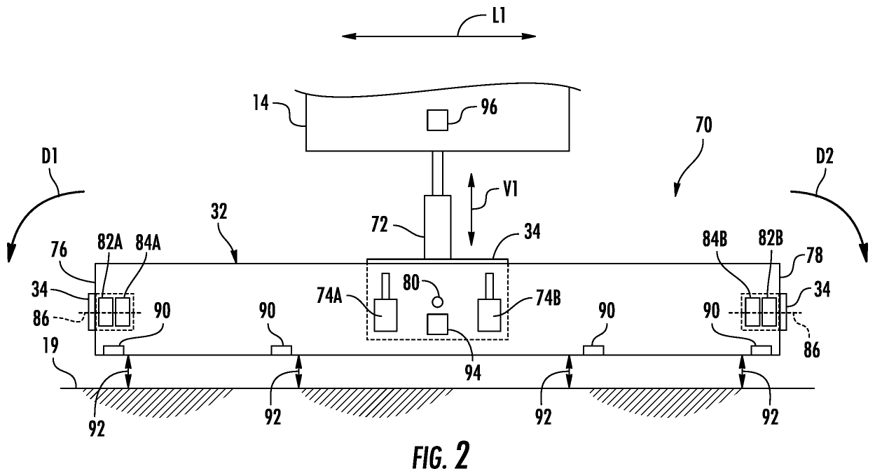

Referring now to FIG. 2, a simplified, schematic view of one embodiment of the header 32 and associated header adjusting system 70 described above with reference to FIG. 1 is illustrated in accordance with aspects of the present subject matter. As indicated above, the height actuator 72 may, for instance, be configured to raise and lower the end of the feeder 34 coupled to the header 32 relative to the frame 14 of the harvester, thereby adjusting the vertical positioning of the header 32 in the vertical direction indicated by arrow V1 (e.g., along a lateral centerline of the feeder 34). For instance, the height actuator 72 may be a cylinder configured to extend and retract to raise and lower the header 32 along the vertical direction V1. However, in other embodiments, the height actuator 72 may be any other suitable type and/or include any suitable number of actuators.

As shown, the header 32 may generally extend side-to-side or in a lateral direction (indicated by arrow L1 in FIG. 2) between a first lateral end 76 and a second lateral end 78. The header 32 may be pivotably coupled to the feeder 34 at one or more locations between its first and second lateral ends 76, 78 to allow the header 32 to tilt laterally relative to the feeder 34 (e.g., in the tilt directions indicated by arrows D1, D2 in FIG. 2) about a lateral tilt axis 80, where the lateral tilt axis 80 is generally aligned with a lateral centerline of the header 32 and extends generally parallel to the direction of movement 21. As indicated above, the header adjusting system 70 may include one or more lateral tilt actuators 74. For instance, as shown in FIG. 2, a first lateral tilt actuator 74A may be coupled between the header 32 and the feeder 34 along one lateral side of the connection between the header 32 and the feeder 34, and a second lateral tilt actuator 74B may be coupled between the header 32 and the feeder 34 along the opposed lateral side of the connection between the header 32 and the feeder 34. In such an embodiment, the lateral tilt actuators 74A, 7B may be configured to pivot or tilt the header 32 about the lateral tilt axis 80 of the header 32 to adjust the orientation of the header 32 in the lateral direction L1. For instance, the lateral tilt actuators 74A, 74B may be cylinders configured to extend and retract to pivot or tilt the header 32 about the lateral tilt axis 80. However, in other embodiments, the lateral tilt actuators 74A, 74B may be any other suitable type and/or include any suitable number of actuators.

Further, as indicated above, the header adjusting system 70 may include one or more fore-aft actuator(s) 82. For instance, a first fore-aft actuator 82A may be coupled between the header 32 and the feeder 34 along one lateral side of the header 32, and a second fore-aft actuator 82B may be coupled between the header 32 and the feeder 34 along the opposed lateral side of the header 32. In such an embodiment, the fore-aft actuators 82A, 82B may be configured to pivot or tilt the header 32 relative to the feeder 34 about a fore-aft tilt axis 86 extending generally parallel to the lateral direction, thereby allowing the orientation of the header 32 to be adjusted in the fore-aft direction FA (FIG. 1) of the header 32. For instance, the fore-aft actuators 82A, 82B may be cylinders configured to extend and retract to pivot or tilt the header 32 about the fore-aft tilt axis 86. It should be appreciated that the first and second fore-aft cylinders 82A, 82B are each shown schematically with a simple box in FIG. 2. However, it should be appreciated that, in other embodiments, the fore-to-aft actuators 82A, 82B may be any other suitable type and/or include any suitable number of actuators.

In some embodiments, as indicated above, the header adjusting system 70 may further include one or more stabilization actuators 84. For instance, a first stabilization actuator 84A may be coupled between the header 32 and the feeder 34 along one lateral side of the header 32, and a second stabilization actuator 84B may be coupled between the header 32 and the feeder 34 along the opposed lateral side of the header 32. In such an embodiment, the stabilization actuators 84A, 84B may be used to reduce, slow down, or prevent rotation of the header 32 about the fore-aft tilt axis 86 in an opposite direction from the desired actuation direction of the fore-aft actuator(s) 82, such as in response to traveling over uneven ground or changing ground speeds. For instance, the stabilization actuators 84A, 84B may be adjustable cylinders configured to prevent, slow down, or reduce unwanted pivot or tilt of the header 32 about the fore-aft tilt axis 86. It should be appreciated that the first and second stabilization cylinders 84A, 84B are each shown schematically with a simple box in FIG. 2. It should be further appreciated that, in other embodiments, the stabilization actuators 84A, 84B may be any other suitable type and/or include any suitable number of actuators.

In general, the operation of the height actuator 72, the lateral tilt actuator(s) 74, the fore-aft tilt actuator(s) 82, and/or the stabilization actuator(s) 84 may be controlled (e.g., via an associated controller or computing system) to adjust the vertical positioning and tilt angle of the header 32 relative to the ground surface 19 and/or the chassis 14 or cab 22. To allow for such header height control, a plurality of height sensors 90 may be provided on the header 32 to monitor one or more respective local distances or heights 92 defined between the header 32 and the ground surface 19. Specifically, as shown in FIG. 2, the header 32 includes four height sensors 90 spaced apart thereon along the lateral direction L1 for monitoring the local height 92 relative to the ground surface 19, such as by including a first height sensor 90 positioned adjacent to the first lateral end 76 of the header 32, a second height sensor 90 positioned adjacent to the second lateral end 78 of the header 32, and third and fourth height sensors 90 positioned between the first and second height sensors 90 along either side of the header centerline. In the illustrated embodiment, the height sensors 90 are spaced apart equally along the lateral width of the header 32. However, in other embodiments, the lateral spacing between the various height sensors 90 may be non-uniform or varied.

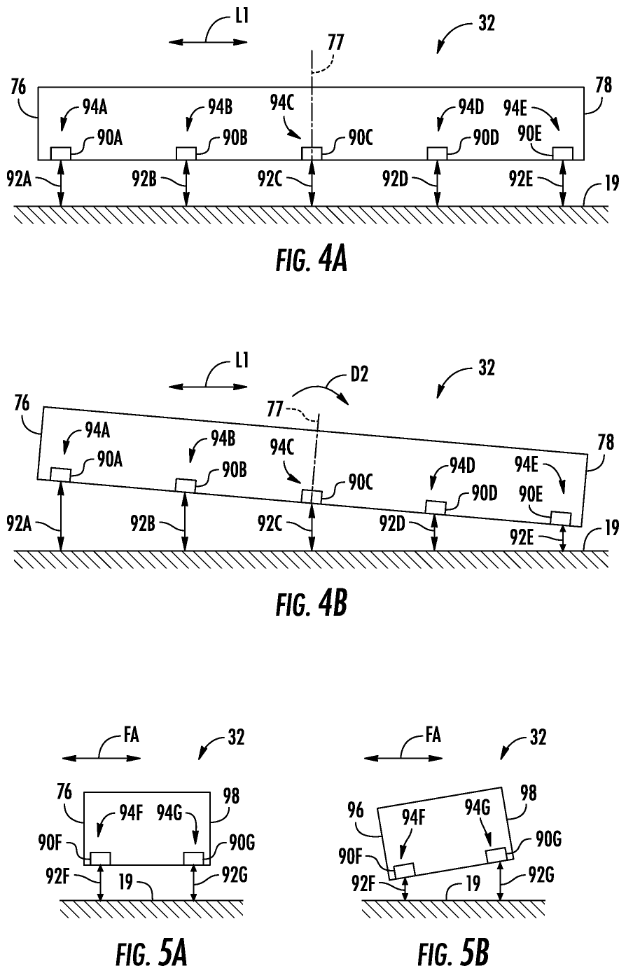

It should be appreciated that, although the header 32 is illustrated herein as including four height sensors 90, any number of height sensors 90 may be installed relative to the header 32 to provide an indication of the local height 92 defined between the header 32 and the ground surface 19 at a corresponding number of lateral sensor positions spaced apart across the lateral width of the header 32. For instance, in other embodiments, three or fewer height sensors 90 may be installed relative to the header 32 or five or more height sensors 90 may be installed relative to the header 32. It should also be appreciated that, in addition to the laterally spaced height sensors 90 (or as an alternative thereto), the header 32 may also include height sensors 90 that are spaced apart from one another in the fore-aft direction FA (FIG. 1) of the header 32. For instance, as will be described below with reference to FIG. 5, one or more height sensors may be installed at a more forward location on the header 32 while one or more

Additionally, it should be appreciated that each height sensor 90 may generally correspond to any suitable sensing device configured to provide sensor data indicative of the local height or distance 92 defined between the header 32 and the ground surface 19 at the installed location of such sensor 90. In the illustrated embodiment, the height sensors 90 comprise non-contact height sensors, such as radar sensors, laser sensors, ultrasonic sensors, and/or the like. Alternatively, the height sensors 90 may comprise contact-based or mechanical height sensors. For instance, in one embodiment, the height sensors 90 may be coupled to mechanical feelers or pivot arms that are configured to contact the ground and pivot up/down with changes in the ground contour, thereby allowing the sensors 90 to detect variations in the local height 92.

In general, the height data provided by the various height sensors 90 may be used as a control input for controlling the operation of the actuators 41, 72, 74, 82, 98 (FIG. 3) to adjust the vertical positioning and tilt angle of the header 32 relative to the ground surface 19. However, as indicated above, accurate header height control requires knowledge of the position of each sensor 90 relative to the header 32. Thus, in accordance with aspects of the present subject matter, systems and methods will be disclosed herein for automatically identifying the relative locations of sensors installed on a header. Upon identification, the sensor locations may be logged or stored for subsequent use. For instance, the identified sensor locations may be used to automatically fine-tune or adjust one or more parameters of the sensors 90 (e.g., sensitivity settings).

Referring now to FIG. 3, a schematic view of one embodiment of a system 100 for automatically identifying sensors associated with agricultural equipment is illustrated in accordance with aspects of the present subject matter. In general, the agricultural system 100 will be described herein with reference to identifying the sensors 90 of the header 32 illustrated in FIGS. 1 and 2. However, it should be appreciated that the disclosed system 100 may be used to automatically identify any suitable sensors of any suitable agricultural equipment, such as other types of agricultural implements, spray booms, and/or the like.

In several embodiments, the agricultural system 100 may include a computing system 102 and various components, features, systems and/or sub-systems configured to be communicatively coupled to the computing system 102. In general, the computing system 102 may be configured to perform various computer-related functions or tasks, including, for example, receiving data from one or more components, features, systems and/or sub-systems of the header 32 and/or associated agricultural harvester 10, storing and/or processing data received or generated by the computing system 102, and/or controlling the operation of one or more components, features, systems and/or sub-systems of the header 32 and/or associated agricultural harvester 10. For instance, as will be described below, the computing system 102 may be configured to automatically execute a sensor identification algorithm or routine to allow for the automatic identification of one or more sensors installed relative to agricultural equipment.

In general, the computing system 102 may correspond to any suitable processor-based device(s), such as a computing device or any combination of computing devices. Thus, as shown in FIG. 3, the computing system 102 may generally include one or more processor(s) 104 and associated memory devices 106 configured to perform a variety of computer-implemented functions (e.g., performing the methods, steps, and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device 106 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device 106 may generally be configured to store information accessible to the processor(s) 104, including data that can be retrieved, manipulated, created and/or stored by the processor(s) 104 and instructions that can be executed by the processor(s) 104.

As further shown in FIG. 3, the computing system 102 is configured to be communicatively coupled to various other components of the system 100. For instance, the computing system 102 is communicatively coupled to the various actuators for controlling movement of the header 32 of the agricultural harvester 10, such as the lift actuator(s) 41, 72, the tilt actuator(s) 74, 82, 98 and the stabilization actuator(s) 84. As such, the computing system 102 may be configured to control an operation of the actuator(s) 41, 72, 74, 82, 84, 98 to move or actuate the header 32 relative to the ground. The computing system 102 is also configured to be communicatively coupled to the height sensors 90. As such, the computing system 102 may be configured to receive data from the height sensors 90 indicative of the height of the header 32 relative to the ground surface 19. In addition, the computing system 102 may be configured to receive identification data from the sensors 90 (e.g., a unique serial number or other identification information), thereby allowing the computing system 102 to identify the source of a given set of distance data. Additionally, the computing system 102 may be configured to be communicatively coupled to a user interface 112 of the agricultural harvester 10. As such, the computing system 102 may be configured to receive inputs from the operator via the user interface 112, and/or control the operation of the user interface 112 to present information to the operator.

In some embodiments, the computing system 102 may be configured to include one or more communications modules or interfaces 108 to allow the computing system 102 to communicate with any of the various system components described herein. For instance, one or more communicative links or interfaces (e.g., one or more data buses) may be provided between the communications interface 108 and each of the actuator(s) 41, 72, 74, 82, 84, 98 to allow the computing system 102 to control the operation of the actuator(s) 41, 72, 74, 82, 84, 98. Similarly, one or more communicative links or interfaces (e.g., one or more data buses) may be provided between the communications interface 108 and the height sensors 90 to allow for communications between the computing system 102 and the sensors 90. Additionally, one or more communicative links or interfaces (e.g., one or more data buses) may be provided between the communications interface 108 and the user interface 112 to allow the computing system 102 to receive inputs from the user interface 112 and/or control the user interface 112 to present information back to the operator.

In accordance with aspects of the present subject matter, the computing system 102 may be configured to execute a sensor identification algorithm or routine to allow for the automatic identification of the sensors 90 on the header 32. For instance, the computing system 102 may be configured to execute such algorithm/routine when the sensors 90 are initially installed onto the header 32 and/or each time one of the sensors 90 is replaced. In one embodiment, to initiate the sensor identification algorithm/routine, the operator may provide an input (e.g., via the user interface 112) requesting that the computing system 102 execute the algorithm/routine. Upon receipt of the request, the computing system 102 may then automatically execute the algorithm/routine without further user interaction.

In several embodiments, to execute the sensor identification algorithm/routine, the computing system 102 may be configured to actuate the header 32 in a manner that causes the orientation of the header 32 to be varied in one or more directions (e.g., in the lateral direction L1 and/or the fore-aft direction FA). As the header 32 is being actuated (and, thus, as the orientation of the header 32 is changing), the computing system 102 may be configured to analyze the data received from the sensors 90 to identify the location of each sensor 90 relative to the header 32. Specifically, based on the position of each sensor 90 on the header 32, the distance detected between the sensor 90 and the ground surface 19 will increase or decrease and/or the magnitude of the change in such distance will vary in degree as the header 32 is being actuated. By recognizing differences in the detected distances between the various sensors 90, the computing system 102 may be configured to automatically identify the relative locations of the sensors 90 along the header 32. For instance, in several embodiments, the computing system 102 may include a plurality of predefined sensor locations stored within its memory 106. In such embodiments, the computing system 102 may be configured to assign each sensor 90 to one of the predefined sensor locations based on the data received from the sensors 90 as the header 32 is being actuated.

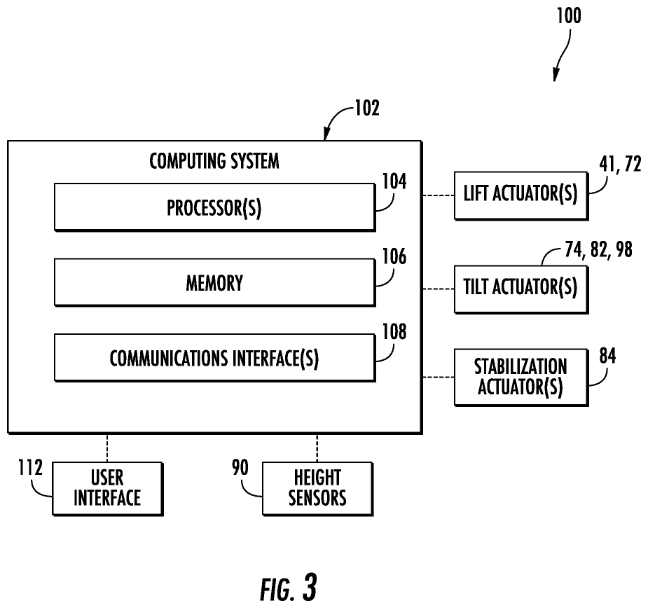

For instance, FIGS. 4A and 4B illustrate schematic views of an exemplary header 32 during the execution of one embodiment of a sensor identification algorithm/routine in accordance with aspects of the present subject matter. As shown in FIGS. 4A and 4B, the header 32 includes five height sensors 90A, 90B, 90C, 90D, 90E installed on the header 32 at spaced apart locations along the lateral direction L1, with each sensor being configured to generate data associated with a local distance 92A, 92B, 92C, 92D, 92E between the sensor and the ground surface at its installed location. In several embodiments, the computing system 102 may include predefined sensor locations 94A, 94B, 94C, 94D, 94E stored within its memory 106 at which the various sensors 90A, 90B, 90C, 90D, 90E are configured to be installed on the header 32. However, upon initial installation of the sensors 94A, 94B, 94C, 94D, 94E, the computing system 102 is unaware of the specific location at which each sensor has been installed. Thus, by executing the sensor identification algorithm/routine, the computing system 102 may assign each sensor to an associated predefined sensor location.

For instance, as shown in FIG. 4A, with the header 32 positioned at a generally horizontal orientation, the local distance 92A, 92B, 92C, 92D, 92E detected by each sensor will generally be the same. However, as shown in FIG. 4B, by actuating the header 32 in a manner that adjusts the lateral orientation of the header 32 relative to the ground surface 19, the local distances will vary based on the relative position of each sensor along the header 32. Specifically, in the illustrated embodiment, the computing system 102 has controlled the operation of the lateral tilt actuator(s) 74 in a manner that causes the header 32 to pivot about its lateral tilt axis 80 (FIG. 2) in a tilt direction D2 such that the first lateral end 76 of the header 32 is raised relative to the ground surface 19 and the second lateral end 78 of the header 32 is lowered relative to the ground surface 19.

In such an embodiment, by analyzing the change (or lack thereof) in the various local distances 92A, 92B, 92C, 92D, 92E as the header 32 is being actuated, the computing system 102 may determine the relative locations of the sensors along the header 32 and, thus, assign each sensor to a respective predefined sensor location 94A, 94B, 94C, 94D, 94E. Specifically, by tilting the header 32 in the manner shown in FIG. 4B, it is generally expected that: (1) the sensors located along the left side of a lateral centerline 77 of the header 32 (e.g., sensors 90A, 90B) will report an increasing distance value; (2) the sensors located along the right side of the lateral centerline 77 of the header 32 (e.g., sensors 90D, 90E) will report a decreasing distance value; and (3) the sensor located at the center of the header 32 (e.g., sensor 90C) will report a substantially constant distance value. Moreover, the sensors positioned further outboard along the header 32 (e.g., sensors 90A, 90E) will report an increasing/decreasing distance value of greater magnitude than the sensors positioned further inboard along the header 32 (e.g., sensors 90B, 90D).

As such, by recognizing whether a given sensor 90 is detecting an increase or decrease in distance relative to the ground surface 19 during actuation of the header 32, the computing system 102 may be determine which side of the header 32 the sensor 90 is located. Additionally, by comparing the magnitude of the increased/decreased distances detected by the sensors 90 located on the same side of the header 32, the computing system 102 may assign relative positions of the sensors 90 along each side of the header 32 (e.g., with greater magnitudes in the changes in the detected distances being located further outboard). For instance, in the illustrated embodiment, the computing system 102 may determine that sensors 90A, 90B both detect increasing distance values and that sensor 90A reports a greater increase in distance than sensor 90B during actuation of the header 32, thereby indicating that sensor 90A is positioned at first lateral outboard location 94A and that sensor 90B is positioned at first lateral inboard location 94B. Additionally, the computing system 102 may determine that sensors 90D, 90E both detect decreasing distance values and that sensor 90E reports a greater decrease in distance than sensor 90D during actuation of the header 32, thereby indicating that sensor 90E is positioned at second lateral outboard location 94E and that sensor 90D is positioned at second lateral inboard location 94D. Further, the computing system 102 may determine that the distance detected by sensor 90C has remained substantially constant during actuation of the header 32, thereby indicating that such sensor 90C is located at the central sensor location 90C.

Referring now to FIGS. 5A and 5B, schematic views of an exemplary header 32 during the execution of another embodiment of a sensor identification algorithm/routine are illustrated in accordance with aspects of the present subject matter. As shown in FIGS. 5A and 5B, in addition to having laterally spaced height sensors 90 (or as an alternative thereto), the header 32 may include two or more height sensors 90 installed on the header 32 at spaced apart locations along the fore-aft direction FA of the header 32. Specifically, in the illustrated embodiment, the header 32 includes two height sensors 90F, 90G installed on the header 32 at spaced apart locations between a forward end 96 and an aft end 98 of the header 32, with each sensor being configured to generate data associated with a local distance 92F, 92G between the sensor and the ground surface 19 at its installed location. Additionally, in several embodiments, the computing system 102 may include predefined sensor locations 94F, 94G stored within its memory 106 at which the sensors 94F, 94G are configured to be installed on the header 32. Thus, to assign each sensor to an associated predefined sensor location, the computing system 102 may be configured to automatically execute a sensor identification algorithm/routine.

For instance, as shown in FIG. 5A, with the header 32 positioned at a generally horizontal orientation, the local distance 92F, 92G detected by each sensor 90F, 90G will generally be the same. However, as shown in FIG. 5B, by actuating the header 32 in a manner that adjusts the fore-aft orientation of the header 32 relative to the ground surface 19, the local distances will vary based on the relative position of each sensor along the header 32. Specifically, in the illustrated embodiment, the computing system 102 has controlled the operation of the fore-aft tilt actuator(s) 92 in a manner that causes the header 32 to pivot about its fore-aft tilt axis 86 (FIG. 2) such that the forward end 96 of the header 32 is lowered relative to the ground and the aft end 98 of the header 32 is raised relative to the ground (or remains at a substantially constant elevation depending on the location of the tilt axis 86).

In such an embodiment, by analyzing the change (or lack thereof) in the local distances 92F, 92G as the header 32 is being actuated, the computing system 102 may determine the relative locations of the sensors along the fore-aft direction FA and, thus, assign each sensor to a respective predefined sensor location 94F, 94G. Specifically, by tilting the header 32 in the manner shown in FIG. 5B, it is generally expected that the sensor located closest to the forward end 96 of the header 32 (e.g., sensor 90F) will report a distance value that is decreased relative to the distance value reported by the sensor located closest to the aft end 98 of the header 32 (e.g., sensor 90G). As such, in the illustrated embodiment, the computing system 102 may determine that sensor 90F has reported a distance value that is significantly less than the distance value reported by sensor 90G, thereby indicating that sensor 90F is positioned at forward-most location 94F and that sensor 90G is positioned at the aft-most location 94G.

It should be appreciated that, in alternative embodiments, the computing system 102 may not include pre-defined sensor locations stored within its memory 106. In such embodiments, as opposed to assigning each sensor to a specific location on the header 32, the computing system 102 may be configured to identify relative locations of the various sensors 90. For instance, referring back to FIGS. 4A and 4B, based on the data received from the various sensors during actuation of the header 32, the computing system 102 may be configured to determine that sensors 90A, 90E are positioned further outboard on the header 32 than sensors 90B, 90D and that all of such sensors 90A, 90B, 90D, 90E are spaced apart from the lateral centerline 77 of the header 32.

As indicated above, in addition to determining the locations of the various sensors 90 on the header 32, the computing system 102 may also be configured to automatically adjust one or more parameters of the sensors 90. For instance, height sensors 90 located closer to the aft end 98 of the header 32 are typically closer to the ground during normal operation than height sensors 90 located closer to the forward end of the 96 of the header 32. As such, upon determining the fore-aft locations of the sensors 90, one or more sensor parameters (e.g., sensitivity settings) may be adjusted to account for the expected differences in relative height from the ground surface 19 during normal operation of the header 32.

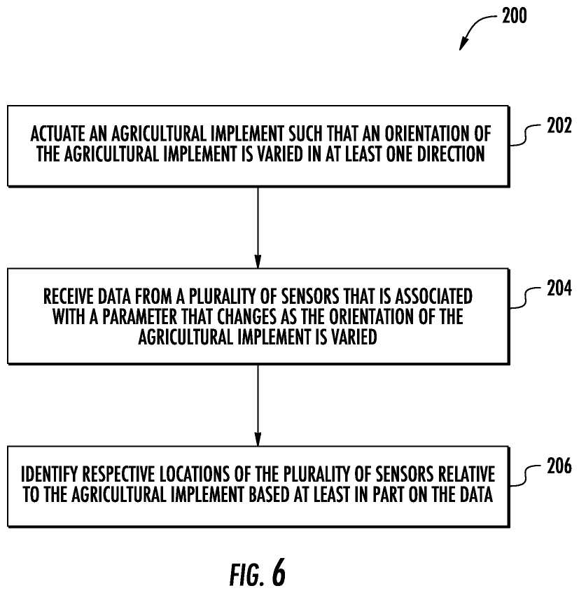

Referring now to FIG. 6, a flow diagram of one embodiment of a method 200 for automatically identifying sensors provided in association with agricultural equipment is illustrated in accordance with aspects of the present subject matter. For purposes of discussion, the method 200 will generally be described herein with reference to the header 32 shown in FIGS. 1 and 2 and the system 100 shown in FIG. 3. However, it should be appreciated that the disclosed method 200 may be executed to automatically identify sensors provided in association with any other suitable equipment having any other suitable equipment configuration. Additionally, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202) the method 200 may include actuating agricultural equipment such that an orientation of the agricultural equipment is varied in at least one direction. For example, as indicated above, the computing system 102 may be configured to automatically control the operation of one or more actuators to actuate the header 32 in a manner that causes the orientation of the header 32 to be varied in one or more directions, such as by controlling the operation of the lateral tilt actuator(s) 74 to cause the orientation of the header 32 relative to the ground surface 19 in the lateral direction L1 to be adjusted and/or by controlling the operation of the fore-aft tilt actuators 82 to cause the orientation of the header 32 relative to the ground surface 19 in the fore-aft direction FA to be adjusted.

Additionally, at (204), the method 200 may include receiving data from a plurality of sensors that is associated with a parameter that changes as the orientation of the agricultural equipment is varied. Specifically, as indicated above, the computing system 102 may be configured to receive data from the height sensors 90 that is associated with the distance defined between each sensor 90 and the ground surface 19. Thus, as the header 32 is being actuated relative to the ground surface 19, the detected distance will generally change with changes in the orientation of the header 32.

Moreover, at (206), the method 200 may include identifying respective locations of the plurality of sensors relative to the agricultural equipment based at least in part on the data. Specifically, as indicated above, by analyzing the data received from the sensors 90, the computing system 102 may identify respective locations of the sensors 90 along the header (including specific predefined locations and relative locations of the sensors 90). For instance, by recognizing whether a given sensor 90 is detecting an increase or decrease in distance relative to the ground surface 19 during actuation of the header 32, the computing system 102 may be determine which side of the header 32 the sensor 90 is located. Additionally, by comparing the magnitude of the increased/decreased distances detected by the sensors 90 located on the same side of the header 32, the computing system 102 may assign relative positions of the sensors 90 along each side of the header 32 (e.g., with greater magnitudes in the changes in the detected distances being located further outboard).

It is to be understood that the steps of the method 200 are performed by the computing system 102 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 102 described herein, such as the method 200, is implemented in software code or instructions which are tangibly stored on a tangible computer readable medium. The computing system 102 loads the software code or instructions via a direct interface with the computer readable medium or via a wired and/or wireless network. Upon loading and executing such software code or instructions by the computing system 102, the computing system 102 may perform any of the functionality of the computing system 102 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for automatically identifying sensors provided in association with agricultural equipment, the method comprising:
actuating, with the computing system, agricultural equipment such that an orientation of the agricultural equipment is varied in at least one direction;
receiving, with the computing system, data from a plurality of sensors that is associated with a parameter that changes as the orientation of the agricultural equipment is varied, the plurality of sensors being installed relative to the agricultural equipment at spaced apart locations along the at least one direction;
identifying, with the computing system, respective locations of the plurality of sensors relative to the agricultural equipment based at least in part on the data.

2. The method of claim 1, wherein the agricultural equipment extends in a fore-aft direction between a forward end and an aft end and in a lateral direction between a first lateral end and a second lateral end, the at least one direction comprising at least one of the fore-aft direction or the lateral direction.

3. The method of claim 2, wherein:
at least a portion of the plurality of sensors are spaced apart along the lateral direction of the agricultural equipment; and
actuating the agricultural equipment comprises actuating the agricultural equipment such that a distance defined between the agricultural equipment and a ground surface is varied at one or more of the spaced apart locations defined along the lateral direction.

4. The method of claim 2, wherein:
at least a portion of the plurality of sensors are spaced apart along the fore-aft direction of the agricultural equipment; and
actuating the agricultural equipment comprises actuating the agricultural equipment such that a distance defined between the agricultural equipment and a ground surface is varied at one or more of the spaced apart locations defined along the lengthwise direction.

5. The method of claim 1, further comprising accessing a plurality of predefined sensor locations associated with the agricultural equipment.

6. The method of claim 5, wherein identifying respective locations of the plurality of sensors comprises assigning each sensor of the plurality of sensors to a respective sensor location of the plurality of predefined sensor locations based at least in part on the data.

7. The method of claim 1, wherein actuating the agricultural equipment comprises actuating the agricultural equipment relative to a ground surface such that the orientation of the agricultural equipment is varied relative to the ground surface in the at least one direction.

8. The method of claim 6, wherein the data received from each sensor of the plurality of sensors is associated with a distance defined between the ground surface and the respective sensor.

9. The method of claim 1, further comprising adjusting a sensor parameter of at least one sensor of the plurality of sensors based at least in part on the identified location of the at least one sensor relative to the agricultural equipment.

10. An automatic sensor identification system, the system comprising:
agricultural equipment;
a plurality of sensors installed relative to the agricultural equipment at a plurality of spaced apart locations along at least one direction; and
a computing system communicatively coupled to the plurality of sensors, the computing system being configured to:
cause the agricultural equipment to be actuated such that an orientation of the agricultural equipment is varied in the at least one direction;
receive data from the plurality of sensors that is associated with a parameter that changes as the orientation of the agricultural equipment is varied; and
identify respective locations of the plurality of sensors relative to the agricultural equipment based at least in part on the data.

11. The system of claim 10, wherein the agricultural equipment extends in a fore-aft direction between a forward end and an aft end and in a lateral direction between a first lateral end and a second lateral end, the at least one direction comprising at least one of the fore-aft direction or the lateral direction.

12. The system of claim 11, wherein:
at least a portion of the plurality of sensors are spaced apart along the lateral direction of the agricultural equipment; and
the computing system is configured to cause the agricultural equipment to be actuated such that a distance defined between the agricultural equipment and a ground surface is varied at one or more of the spaced apart locations defined along the lateral direction.

13. The system of claim 11, wherein:
at least a portion of the plurality of sensors are spaced apart along the fore-aft direction of the agricultural equipment; and
the computing system is configured to cause the agricultural equipment to be actuated such that a distance defined between the agricultural equipment and a ground surface is varied at one or more of the spaced apart locations defined along the fore-aft direction.

14. The system of claim 10, wherein the computing system is further configured to access a plurality of predefined sensor locations associated with the agricultural equipment.

15. The system of claim 14, wherein the computing system is configured to assign each sensor of the plurality of sensors to a respective sensor location of the plurality of predefined sensor locations based at least in part on the data.

16. The system of claim 10, wherein the computing system is configured to cause the agricultural equipment to be actuated such that the orientation of the agricultural equipment is varied relative to the ground surface in the at least one direction.

17. The system of claim 16, wherein the data received from each sensor of the plurality sensors is associated with a distance defined between the ground surface and the respective sensor.

18. The system of claim 10, wherein the computing system is further configured to adjust a sensor parameter of at least one sensor of the plurality of sensors based at least one part on the identified location of the at least one sensor relative to the agricultural equipment.

19. The system of claim 10, wherein the agricultural equipment comprises a header configured for use with an agricultural harvester.

20. The system of claim 19, wherein the plurality of sensors comprise a plurality of height sensors configured to provide an indication of a position of the header relative to a ground surface.
